(19) United States
(12) Patent Application Publication
(10) Pub. No.: US 2002/0105626 A1
(43) Pub. Date: Aug. 8, 2002

(54) Method of making hard copy prints of successively spaced pairs of half-frame film images

(75) Inventor: Joel S. Lawther, East Rochester, NY (US)

Correspondence Address: Patent Legal Staff, Eastman Kodak Company, 343 State Street, Rochester, NY, 14650-2201, US

(73) Assignee: Eastman Kodak Company

(21) Appl. No.: 09/736,088

(22) Filed: Dec. 13, 2000

(51) Int. Cl. G03B 27/52

(52) U.S. Cl. 355/40; 355/77

(57) ABSTRACT

A print-making method makes hard copy prints of half-frame film images arranged on a standard filmstrip in successive pairs. The pairs of half-frame film images are evenly spaced from one another, and the half-frame film images in each pair slightly overlap along one of their edges. The method comprises the steps of: dividing a single digital half-frame image file of slightly overlapping electronic half-frame images formed from a pair of slightly overlapping half-frame film images into one digital half-frame image file that corresponds to one of the pair of half frame film images and into another digital half-frame image file that corresponds to the other of the pair of half-frame film images, in order to eliminate the image overlap; separately subjecting the two digital half-frame image files to image enhancement algorithms to improve picture quality; and making a pair of hard copy prints from the two digital half-frame image files.

### FIELD OF THE INVENTION

The invention relates generally to the field of print-making in photography. In particular, the invention relates to a method of making hard copy prints of successively spaced pairs of half-frame negative or positive images on a standard filmstrip.

### BACKGROUND OF THE INVENTION

The term “half-frame” as contrasted with the term “full-frame” refers to the fact that each successive picture area or frame on a 35 mm filmstrip is 18×24 mm rather than 24×36 mm. Thus, a standard 36-exposure 35 mm filmstrip when exposed in a camera for making half-frame exposures would yield 72 exposures.

Prior art, commonly assigned U.S. Pat. No. 5,541,690, issued Jul. 30, 1996, discloses a camera for making half-frame exposures on a standard 35 mm filmstrip. The half-frame exposures are arranged in successive pairs that are evenly spaced from one another, and the half-frame exposures in each pair slightly overlap along one of their edges. The space between successive pairs of half-frame exposures is equal to the space between successive full-frame exposures on a standard 35 mm filmstrip, and the size of each pair of half-frame exposures is substantially equal to the size of a full-frame exposure on a standard 35 mm filmstrip. This conveniently allows the paired half-frame exposures to be printed using a standard 35 mm printer system. To make prints, a pair of half-frame negatives are exposed simultaneously on a single sheet of sensitized paper to provide slightly overlapping images on the paper. The half frame prints are then cut apart at their overlapping edges to provide separate hard copy prints.

### Problem

In U.S. Pat. No. 5,541,690, a pair of half-frame exposures are made successively in the camera. Consequently, the pair of half frame negatives often differ in regard to various photographic parameters, such as intensity and color of scene illuminant, scene subject matter, scene contrast, subject matter defects (e.g. red-eye), sharpness, and under- or over-exposure, etc.

The problem is that any of the known image enhancement computer algorithms that are normally used in the printer system to improve picture quality treat the pair of half-frame negatives as a single full-frame negative, ignoring the differences between the paired half-frame negatives. Thus, the improvement to picture quality cannot reach its full potential.

Prior art, commonly assigned U.S. Pat. No. 6,072,563, issued Jun. 6, 2000, discloses a printer system for exposing two or more successive full-frame negatives simultaneously on a single sheet of sensitized paper in order to increase printing speed. The two or more negatives are analyzed to determine color balance and density values of each negative. Then, separate exposure control means are individually operated to correct for any errors in color balance and density of the negatives during their simultaneous exposure on the sensitized paper. This requires at least two exposure control means which can be cost-prohibitive.

### SUMMARY OF THE INVENTION

A method of making hard copy prints of half-frame film images that are arranged on a standard filmstrip in successive pairs which are evenly spaced from one another, and the half-frame film images in each pair slightly overlap along one of their edges, said method comprising:

dividing a single digital half-frame image file of slightly overlapping electronic half-frame images formed from a pair of slightly overlapping half-frame film images into one digital half-frame image file that corresponds to one of the pair of half frame film images and into another digital half-frame image file that corresponds to the other of the pair of half-frame film images, in order to eliminate the image overlap;

separately subjecting the two digital half-frame image files to image enhancement algorithms to improve picture quality; and

making a pair of hard copy prints from the two digital half-frame image files.

### BRIEF DESCRIPTION OF THE DRAWINGS

FIG. 1 is a plan view of a filmstrip having successive pairs of different half-frame film images;

FIG. 2 is a block form depiction of a printer system; and

FIG. 3 is a flow chart diagram of a method of making hard copy prints of the paired half-frame film images on the filmstrip shown in FIG. 1.

### DETAILED DESCRIPTION OF THE INVENTION

The invention is disclosed as being embodied in a digital printer system. Because the features of a digital printer system are generally known, the description which follows is directed in particular only to those elements forming part of or cooperating directly with the disclosed embodiment. It is to be understood, however, that other elements may take various forms known to a person of ordinary skill in the art.

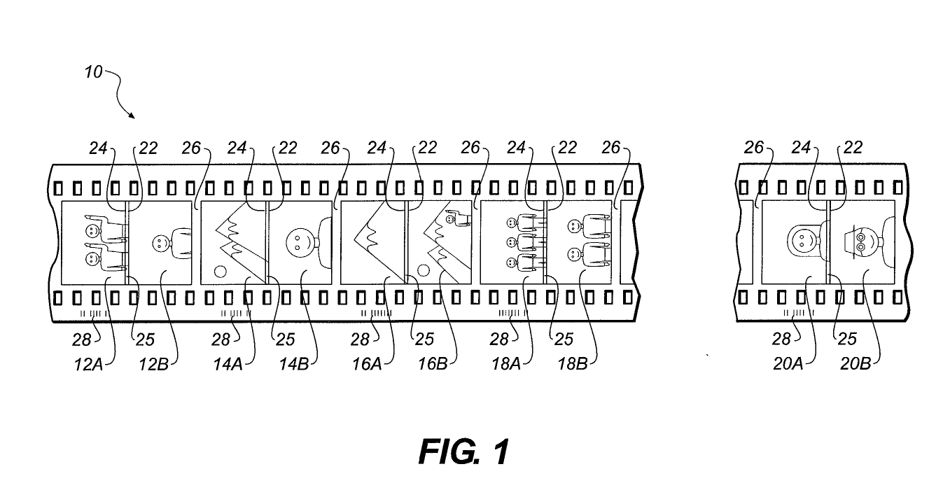

### The Filmstrip—FIG. 1

FIG. 1 shows a standard color negative 35 mm filmstrip 10 having thirty-six successive pairs of different half-frame film negative images 12A, 12B, 14A, 14B, 16A, 16B, 18A, 18B, . . . 20A, 20B, . . . . The term “half-frame” as contrasted with the term “full-frame” refers to the fact that each half-frame film image 12A, 12B, 14A, 14B, 16A, 16B, 18A, 18B, . . . 20A, 20B, . . . is 18×24 mm rather than 24×36 mm. This allows twice as many half-frame film images 12A, 12B, 14A, 14B, 16A, 16B, 18A, 18B, . . . 20A, 20B, . . . on the filmstrip 10 as compared to full-frame film images. Thus, a standard 36-exposure 35 mm filmstrip when exposed in a camera for making half-frame exposures, such as the one disclosed in U.S. Pat. No. 5,541,690, would yield 72 exposures.

As shown in FIG. 1, the pairs of half-frame film negative images 12A, 12B, 14A, 14B, 16A, 16B, 18A, 18B, . . . 20A, 20B, . . . on the filmstrip 10 are evenly spaced from one another, and the half-frame film images in each pair slightly overlap along one of their edges 22 and 24. The image overlap 25 between the edges 22 and 24 is no more than 2 mm. The space 26 between the pairs of half-frame film images 12A, 12B, 14A, 14B, 16A, 16B, 18A, 18B, . . . 20A, 20B, . . . is equal to the space between successive full-frame film images on a standard 35 mm filmstrip, and the size of each pair of half-frame film images is substantially equal to the size of a full-frame film image on a standard 35 mm filmstrip.

A series of identical half-frame indications 28 are provided on the filmstrip 10 adjacent the first one of the half-frame film negative images 12A, 12B, 14A, 14B, 16A, 16B, 18A, 18B, . . . 20A, 20B, . . . in each pair. The first ones of the paired half-frame images in FIG. 1 are 12A, 14A, 16A, 18A, and 20A. Each half-frame indication 28 serves as a unique indication that a pair of half-frame film images which slightly overlap along one of their edges 22 and 24 are captured on the filmstrip 10. The half-frame indications 28 can be an illustrated bar code that is provided on the filmstrip 10 during film manufacture. Alternatively, the half-frame indications 28 can be other known means such as an optical encodement that is exposed on the filmstrip as an incident to picture-taking, or a magnetic encodement that is recorded on a magnetic track on the filmstrip during film advance following each exposure.

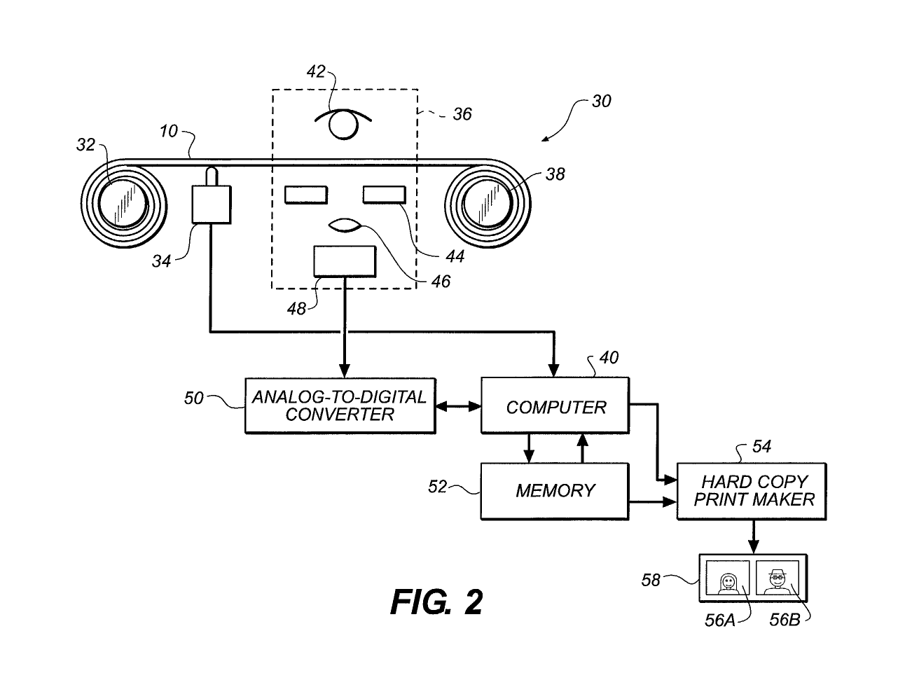

### The Printer System—FIG. 2

FIG. 2 shows a printer system 30 in block form, which is used to make hard copy prints of the pairs of slightly overlapping half-frame film images 12A, 12B, 14A, 14B, 16A, 16B, 18A, 18B, . . . 20A, 20B, . . . on the filmstrip 10.

The printer system 30 includes a known motorized film drive (not shown) for advancing the filmstrip 10 from a film supply reel 32, over a known digital reader 34, through a known digital scanner 36, and onto a film take-up reel 38. The reader 34 reads the half-frame indication 28 adjacent the first one of the slightly overlapping half-frame film negative images in each pair 12A, 12B, 14A, 14B, 16A, 16B, 18A, 18B, . . . 20A, 20B, . . . on the filmstrip 10 and inputs it in digital form to a known computer 40. The scanner 36 has a projection light source 42 that shines bright light simultaneously through a pair of slightly overlapping half-frame film images when that pair is momentarily positioned at a full-frame film gate 44, and has a focusing lens 46 that focuses a single light-projected image of the pair of half-frame film images at the full-frame film gate onto a scanning image sensor 48 such as a charge-coupled device (CCD). A resultant analog pair of slightly overlapping half-frame electronic images formed from the pair of half-frame film images at the full-frame film gate 44 is captured by the image sensor 48, and is provided to a known analog-to-digital converter 50. When the converter 48 accumulates a pair of slightly overlapping half-frame electronic images formed from a pair of half-frame film images at the full-frame film gate 44, the converter is controlled by the computer 40 to convert the pair of half-frame electronic images into a single digital half-frame image file and to input the single half-frame digital file to the computer. The single digital half-frame image file is a digital representation of the pair of slightly overlapping half-frame electronic images and is made consistent with known analog to digital image conversion techniques. The computer 40 has a image data manager (not shown) that is instructed via software to divide the single digital half-frame image file of the pair of slightly overlapping electronic images into a pair of digital half-frame image files which are then stored in a known memory 52 connected to the computer. The first one of the pair of digital half-frame image files digitally represents the first one of a pair of half-frame electronic images, and the second one of the pair of digital half-frame image files digitally represents the second one of the pair of half-frame electronic images. Thus, the overlap 25 is eliminated.

A counter (not shown) in the computer 40 assigns successive numbers to the digital half-frame image files in each pair of digital half-frame image files that is created in the computer and stored in the memory 52. The successive numbers are used to successively number the hard copy prints to be made.

Any one of the pairs of half-frame film images 12A, 12B, 14A, 14B, 16A, 16B, 18A, 18B, . . . 20A, 20B, . . . on the filmstrip 10 can differ in regard to various photographic parameters, such as intensity and color of scene illuminant, scene subject matter, scene contrast, subject matter defects (e.g. red-eye), sharpness, under- or over-exposure, etc. A plurality of known image enhancement algorithms used to improve picture quality, such as disclosed in commonly assigned U.S. Pat. Nos. 6,097,470 and 6,097,471, issued Aug. 1, 2000, are stored in the memory 50. For example, the image enhancement algorithms can include an under-exposure gamma adjustment algorithm to increase the under-exposure gamma of a digital color image, a scene balance algorithm to produce a balanced digital color image, a contrast normalization algorithm, a sharpening algorithm, a red-eye removal algorithm, etc. The computer 40 subjects the two digital half-frame image files in each pair of digital half-frame image files that is created in the computer to the image enhancement algorithms. Thus, picture-quality can be improved according to known digital techniques.

A known hard copy print maker 54 is connected to the computer 40 to make a pair of hard copy prints for each pair of digital half-frame image files that have been subjected to the image enhancement algorithms. A pair of hard copy prints 56A, 56B can be printed simultaneously (or successively) on a single sheet of sensitized paper 58 (or on successive pieces of the paper) without the overlap 25. See FIG. 2.

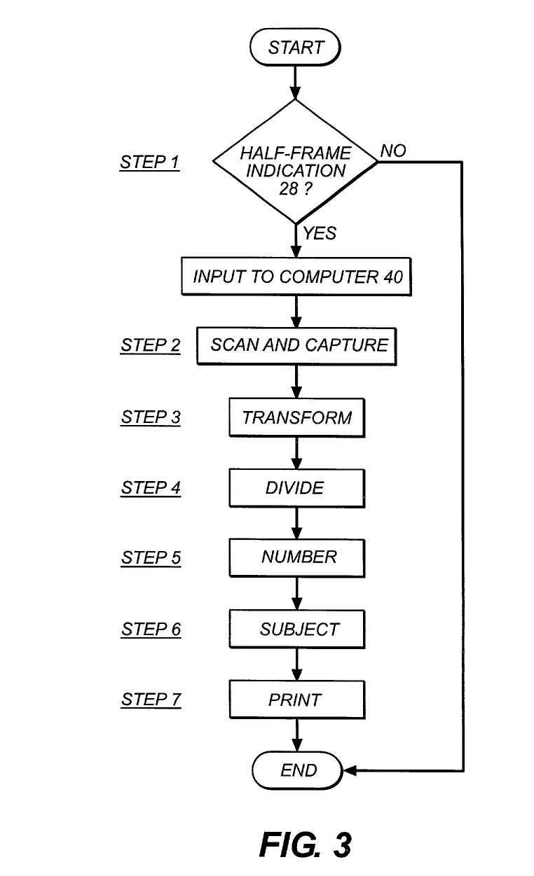

### The Method—FIG. 3

A method of making hard copy prints of the pairs of slightly overlapping half-frame film images 12A, 12B, 14A, 14B, 16A, 16B, 18A , 18B, . . . 20A, 20B, . . . on the filmstrip 10 is shown in FIG. 3. The method comprises the following steps.

STEP 1: Determining via the reader 34 whether the half-frame indication 28 is present adjacent a first one the first one of the slightly overlapping half-frame film images in any pair 12A, 12B, 14A, 14B, 16A, 16B, 18A, 18B, . . . 20A, 20B, . . . on the filmstrip 10, and when determined to be present inputting it in digital form to the computer 40.

STEP 2: Scanning via the scanner 36 a pair of slightly overlapping half-frame film images simultaneously at the film gate 44, and capturing via the image sensor 48 an analog pair of slightly overlapping half-frame electronic images of the scanned half-frame film images.

STEP 3: Transforming via the converter 50 and the computer 40 the analog pair of slightly overlapping half frame electronic images into a single digital half-frame image file which digitally represents the pair of half-frame electronic images;

STEP 4: Dividing via the computer 40 the single digital half-frame image file representing a pair of slightly overlapping half frame electronic images into one digital half-frame image file that digitally represents one of the pair of half frame electronic images and into another digital half-frame image file that digitally represents the other of the pair of half-frame electronic images, in order to eliminate the image overlap.

STEP 5: Successively numbering the pair of digital half-frame image files.

STEP 6: Separately subjecting the pair of digital half-frame image files to image enhancement algorithms to improve picture quality.

STEP 7: Making a pair of hard copy prints 56B, 56B from the pair of digital half-frame image files on the same piece of sensitized material 58.

In this method, STEPS 5 and 6 can be reversed in the given order.

The invention has been described with reference to a preferred embodiment. However, it will be appreciated that variations and modifications can be effected by a person of ordinary skill in the art without departing from the scope of the invention.

PARTS LIST

| | |
|---|---|
| 10. | filmstrip |
| 12A, 12B. | pair of half-frame film images |
| 14A, 14B. | pair of half-frame film images |
| 16A, 16B. | pair of half-frame film images |
| 18A, 18B. | pair of half-frame film images |
| 20A, 20B. | pair of half-frame film images |
| 22. | edge |
| 24. | edge |
| 25. | image overlap |
| 26. | space |
| 28. | half-frame indication |
| 30. | printer system |
| 32. | film supply reel |
| 34. | digital reader |
| 36. | digital scanner |
| 38. | film take-up reel |
| 40. | computer |
| 42. | projection light source |
| 44. | full-frame film gate |
| 46. | focusing lens |
| 48. | scanning image sensor |
| 50. | analog-to-digital converter |
| 52. | memory |
| 54. | hard copy print maker |
| 56A, 56B. | hard copy prints |
| 58. | sensitized paper |

What is claimed is:

1. A method of making hard copy prints of half-frame film images that are arranged on a standard filmstrip in successive pairs which are evenly spaced from one another, and the half-frame film images in each pair slightly overlap along one of their edges, said method comprising:
dividing a single digital half-frame image file of slightly overlapping electronic half-frame images formed from a pair of slightly overlapping half-frame film images into one digital half-frame image file that corresponds to one of the pair of half frame film images and into another digital half-frame image file that corresponds to the other of the pair of half-frame film images, in order to eliminate the image overlap;
separately subjecting the two digital half-frame image files to image enhancement algorithms to improve picture quality; and
making a pair of hard copy prints from the two digital half-frame image files.

2. A method of making hard copy prints of half-frame film images that are arranged on a standard filmstrip in successive pairs which are evenly spaced from one another, and the half-frame film images in each pair slightly overlap along one of their edges, said method comprising:
determining whether a half-frame indication is present on the filmstrip which serves as a unique indication that a pair of half-frame film images which slightly overlap along one of their edges are captured on the filmstrip;
scanning the pair of slightly overlapping half-frame film images on the filmstrip to create an analog pair of slightly overlapping half-frame electronic images of the half-frame film images;
transforming the pair of slightly overlapping half frame electronic images into a single digital half-frame image file which represents the pair of slightly overlapping half-frame electronic images;
dividing the single digital half-frame image file which represents the pair of slightly overlapping half-frame electronic images into one digital half-frame image file that represents one of the pair of half frame electronic images and into another digital half-frame image file that represents he other of the pair of half-frame electronic images, in order to eliminate the image overlap;
successively numbering the two digital half-frame image files;
separately subjecting the two digital half-frame image files to image enhancement algorithms to improve picture quality; and
making a pair of hard copy prints from the two digital half-frame image files.

3. A method as recited in claim 2, wherein the pair of hard copy prints made from the two digital half-frame image files are made on the same piece of sensitized material.

4. A printer system for making hard copy prints of half-frame film images that are arranged on a standard filmstrip in successive pairs which are evenly spaced from one another, and the half-frame film images in each pair slightly overlap along one of their edges, said printer system comprising:
means for dividing a single digital half-frame image file of slightly overlapping electronic half-frame images formed from a pair of slightly overlapping half-frame film images into one digital half-frame image file that corresponds to one of the pair of half frame film images and into another digital half-frame image file that corresponds to the other of the pair of half-frame film images, in order to eliminate the image overlap;
means for separately subjecting the two digital half-frame image files to image enhancement algorithms to improve picture quality; and
means for making a pair of hard copy prints from the two digital half-frame image files.
